(19) United States
(12) Patent Application Publication
(10) Pub. No.: US 2026/0219084 A1
(43) Pub. Date: Jul. 30, 2026

(54) APPARATUS AND METHOD FOR MEASURING CRYOGENIC EXHAUST FLOW

(71) Applicant: Messer Industries USA, Inc., Bridgewater, NJ (US)

(72) Inventor: John Griffiths, Shaker Heights, OH (US)

(73) Assignee: Messer Industries USA, Inc., Bridgewater, NJ (US)

(21) Appl. No.: 19/379,818

(22) Filed: Nov. 5, 2025

Related U.S. Application Data
(60) Provisional application No. 63/750,326, filed on Jan. 28, 2025.

(51) Int. Cl. G01F 1/696; F25D 29/00

(52) U.S. Cl. CPC G01F 1/696; F25D 29/001

(57) ABSTRACT

An apparatus for measuring flow of cryogen exhaust gas from a freezer includes a flow probe including a first resistive heater and a second resistive heater, the first and second resistive heaters adapted for being exposed to the cryogen exhaust gas; and a flow probe control coupled to the first resistive heater and the second resistive heater, the flow probe control including a control circuit constructed and arranged to: operate the first resistive heater at a first temperature, operate the second resistive heater at a second temperature different from the first temperature, wherein the first temperature and the second temperature each remain constant and greater than a predetermined threshold temperature, and determine a heat transfer coefficient for the flow of the cryogen exhaust gas over the first and second resistive heaters. A related method is also provided.

### BACKGROUND OF THE INVENTION

The present embodiments relate to apparatus and methods for measuring cryogenic environments used for processing products such as for example food products.

Industrial apparatus for the processing of products, such as food products, often employ various devices for measuring characteristics and/or operating conditions of the apparatus and the environment in which the apparatus is operating. One example of an industrial apparatus is an industrial freezer that may be used to freeze food products during processing of such food products for storage, transport, and/or further processing. A cryogen may be used to quickly and efficiently freeze or chill such food products. The cryogen is typically controlled and/or dispensed at extremely low temperatures to quickly chill and freeze the food products in an industrial environment.

The extremely low temperatures of the cryogen used in industrial freezers present challenges for their efficient and safe operation in an industrial setting. As a result, existing industrial freezer implementations may suffer from various drawbacks. For example, exhaust systems, which are used in industrial freezer settings to expel spent cryogen, may fail because their components (e.g., exhaust blower, exhaust duct, exhaust measurement devices, etc.) become fouled and/or inoperable due to the accumulation of ice from the extremely low temperatures in which the components must operate. When the exhaust system components and/or related systems fail, become inoperable, and/or deliver inaccurate information, freezer operations must cease in order to inspect and correct such failures, ensure appropriate safety protocols are in place, perform maintenance, and/or verify proper operation before the freezing of the food products can be resumed. Thus, as a result of these and other deficiencies, existing industrial freezer operations suffer from increased processing times, higher costs, and risks to operator safety. Therefore, there exists a need for apparatus and methods that operate more continuously, reliably, efficiently and safely in the extreme environments of industrial freezing processes than known apparatus and methods.

### SUMMARY OF THE INVENTION

This section provides a general summary of the disclosed embodiments.

There is provided herein an apparatus for measuring flow of cryogen exhaust gas from a freezer. The apparatus comprises a flow probe comprising a first resistive heater and a second resistive heater, the first and second resistive heaters adapted for being exposed to the cryogen exhaust gas; and a flow probe control coupled to the first resistive heater and the second resistive heater, the flow probe control comprising a control circuit constructed and arranged to: operate the first resistive heater at a first temperature, operate the second resistive heater at a second temperature different from the first temperature, wherein the first temperature and the second temperature each remain constant and greater than a predetermined threshold temperature, and determine a heat transfer coefficient for the flow of the cryogen exhaust gas over the first and second resistive heaters.

A method is also provided herein for measuring flow of cryogen exhaust gas from a freezer. The method comprises energizing a first resistive heater with a first voltage to maintain a first temperature; energizing a second resistive heater with a second voltage to maintain a second temperature different from the first temperature; controlling the first temperature and the second temperature to be constant; wherein the first temperature and the second temperature are greater than a predetermined threshold temperature; positioning the first and second resistive heaters in the cryogen exhaust gas; and determining a heat transfer coefficient for the flow of the cryogen exhaust gas over the first and second resistive heaters.

Further applicability of the present embodiments will become apparent from the description provided herein. The description and specific examples herein are intended for purposes of illustration only and are not intended to limit the scope of the present embodiments.

### BRIEF DESCRIPTION OF THE DRAWINGS

For a more complete understanding of the present invention, reference may be had to the following description of exemplary embodiments considered in connection with the accompanying drawing Figures, of which:

FIG. 1 is a schematic view of an example of a cryogenic processing environment that includes an embodiment of an apparatus in accordance with the present invention.

FIG. 2 is a schematic view showing a portion of the cryogenic processing environment and the apparatus of FIG. 1.

FIGS. 3A and 3B are schematic views of an assembly used with the apparatus of FIG. 2.

FIG. 4 is a diagram of an electrical circuit that is used in the apparatus of FIG. 2.

FIG. 5 is a schematic view of an example of a cryogenic processing environment that includes another embodiment of an apparatus in accordance with the present invention.

Corresponding reference numerals indicate corresponding elements throughout the several views of the drawings.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

The embodiments of the present disclosure are directed to flow probes that may be used to determine a velocity and/or flow of gas moving through a chamber. The embodiments of the present disclosure may be used, for example, to determine a velocity of cryogen exhaust gas that flows out of an exhaust duct of a freezer or freezer system, such as an industrial freezer used in a food processing environment. Such freezers may use a cryogen such as nitrogen (N₂) or carbon dioxide (CO₂) to quickly and thoroughly chill or freeze food products. The freezers may dispense the cryogen onto the food products at an extremely low temperature (e.g., −100° F./−73° C., or lower) to chill or freeze the food products.

The cryogen may be dispensed, for example, in a tunnel or other chamber of the freezer. The cryogen in the tunnel or other chamber reduces substantially a temperature of same such that cooled or colder atmosphere in the tunnel or other chamber, which may have some cryogen gas therein, is removed via an exhaust duct for the freezer. Without exhausting the cryogen, or if the cryogen is not sufficiently exhausted, the cryogen functions as an asphyxiant or toxin through accumulation and displacement of ambient air in a processing facility housing the industrial freezer. This asphyxiant may cause safety concerns for personnel proximate to the freezer or in the processing facility. It is important, therefore, to measure the flow of the cryogen exhaust gas to determine whether the exhaust process is properly working. This allows the freezing process to safely continue operation.

As mentioned above, existing systems and methods for measuring the flow of cryogen exhaust gas in freezing processes suffer from various drawbacks. For example, the extremely low temperatures of the cryogen exhaust gas may lead to the accumulation of ice on various pieces of equipment such as sensors, probes, and the like. The accumulation of ice and/or the extremely low operating temperatures can lead to the failure of the sensors or other measurement equipment. In other instances, the low temperatures and/or ice may cause inaccurate measurements to be determined and/or delivered from the sensors or other measurement equipment. The failure of such sensors or the inaccurate measurements by the sensors can result in incorrect operation of the freezer and/or continued operation of the freezer when cryogen exhaust gas is not being properly exhausted from the processing facility. Still further, the inaccuracies and/or failures may lead to intermittent stoppages of the freezing process. Such problems can lead to increased costs, inefficient operation, increased maintenance, and safety concerns.

Existing freezer systems measure exhaust flow by utilizing conventional flow sensors such as vane anemometers or differential pressure transmitters. These devices, however, suffer from many of the deficiencies described above. Vane anemometers, for example, typically include a vane that rotates in the presence of a moving gaseous flow. The vane can be used to measure a velocity of cryogen exhaust gas moving in an exhaust duct by detecting or sensing a rotation of the vane that is positioned inside the duct. The cryogen exhaust gas that moves past the vane may include ice, frozen food particles, and other materials that may accumulate on the vane. Vane anemometers used in an exhaust duct of an industrial freezer environment are prone to becoming fouled by the ice and other material. This fouling material inhibits the rotation of the vane and leads to failure and/or inaccurate measurements of the velocity of the cryogen exhaust gas. As a result, vane anemometers can only be used for very brief periods of time, after which the vane anemometers must be removed, heated, and/or repaired before operations can continue.

Differential pressure transmitter systems also suffer from the deficiencies discussed above, particularly when used in an industrial freezer environment. Indeed, differential pressure transmitter systems typically include piping or tubing having a small inner diameter that are placed at various locations along a cryogen exhaust duct to measure a difference in pressure between two distinct points. Differential pressure can be measured between various locations along the cryogen exhaust duct to determine a flow of the cryogen exhaust gas through the exhaust duct. The piping or tubing of differential pressure transmitter systems can become clogged, restricted, or otherwise fouled by the ice, food particles or other frozen materials in the exhaust duct. This fouling often leads to the failure and/or inaccurate measurement of the flow of the cryogen exhaust gas in the exhaust duct. When such failures or inaccuracies occur, the differential pressure transmitter systems must be taken offline for cleaning, maintenance and/or repair.

Sensors which utilize heated probes which either oscillate or change temperature can provide inaccurate reading as a result of the combination of the specific heat capacity, mass, and temperature change of the probe. During periods of temperature change, power is either consumed or released by the probe. This will create erroneous readings in the probe power requirements. Further, the thermal gradient within the probe will change, creating a significant deviation in the temperature measured and the probe's surface temperature. When such deviations occur, a probe might indicate a flow significantly different from the actual flow occurring. This might lead to false readings, inferring acceptable flow when in fact insufficient flow exists.

Having recognized a need in the freezer industry, and the limitations and deficiencies of existing devices used in such industry to measure exhaust flow of cold gases in cold or sub-freezing environments, the present embodiments provide apparatus and methods in the tunnel or other chamber or overcoming the limitations and deficiencies of existing devices and methods. The apparatus and methods of the present embodiments disclosed may include flow probes and related controls that are improvements over vane anemometers, differential pressure systems and other existing measurement devices and systems. In some of the present embodiments, the apparatus and methods include a flow probe that may be positioned in a cryogen exhaust duct and operated without interruption in low temperature environments. In some embodiments, the flow probe according to the present disclosure may include a resistive heater that may be used to measure a flow of cryogen exhaust gas and may be operated at multiple elevated temperatures. The elevated operating temperatures of the flow probe of the present embodiments enable the flow probe to remain free of ice and as a result, deliver accurate flow measurements without interruption. The accurate, uninterrupted flow measurement by the apparatus and methods of the present embodiments results in lower costs, improved reliability, less downtime and maintenance, and improved efficiency and safety over existing systems and methods.

The discussion above and the further description below provide a flow probe that may be used in the context of an industrial food processing freezer environment. It should be appreciated, however, that application of the embodiments of the present disclosure are not limited to food processing applications. The embodiments of the present disclosure may also be used in, for example, medical chilling and freezing applications, pharmaceutical chilling and freezing applications or other chilling and freezing applications.

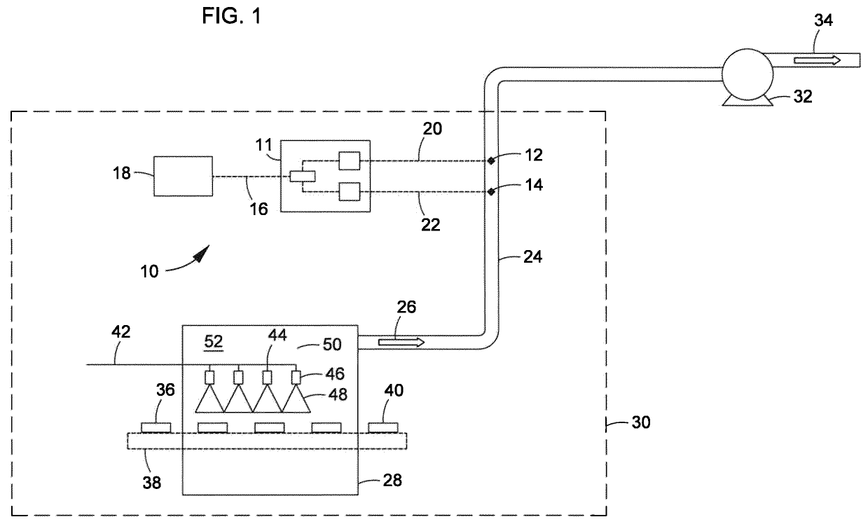

Referring now to FIG. 1, there is provided an apparatus shown generally at 10 in order to measure a velocity of spent cryogen exhaust gas 26 moving through exhaust duct 24, a probe control unit 11 to maintain a first temperature of probe 12 (A) and a second temperature of probe 14 (B). The probe control unit 11 then calculates the velocity or heat transfer coefficient utilizing information from the first and second flow probes 12,14 and sends this value via output signal 16 to a display unit 18 where the value is displayed.

Spent cryogen exhaust gas 26 originates as shown in cryogenic processing equipment 28. In the example shown, the cryogenic processing equipment 28 is contained within processing building 30 (or “building”) or environment. The cryogenic processing equipment 28 may be a freezer that includes a conveyor 38 configured to move or transport warm (or ambient temperature) food products 36 disposed on the conveyor through the cryogenic processing equipment 28, after which the food products are transformed into chilled or frozen food products 40.

The cryogenic processing equipment 28 may include a spray header assembly 44 that supplies a feed cryogen 42 to one or a plurality of spray nozzles 46 that dispense the feed cryogen 42 as a spray 48 onto the food products 36 as they are transported on the conveyor 38 to pass through the cryogenic processing equipment 28.

After the feed cryogen 42 is dispensed onto the food products 36, spent cryogen exhaust gas 26 may be removed from the cryogenic processing equipment 28 and from the building 30 through the exhaust duct 24 as cryogen exhaust. The exhaust duct 24 may include a channel through which the spent cryogen exhaust gas 26 is moved from the cryogenic processing equipment 28 to a location external to the building 30. In the example shown, a blower 32 is fluidly coupled to the exhaust duct 24 to assist in moving the spent cryogen exhaust gas 26 toward an exhaust outlet 34. The exhaust duct 24 can be fluidly coupled at one end to the cryogenic processing equipment 28 through a wall of the building 30 and at another end to the exhaust outlet 34. As further shown, the cryogenic processing equipment 28 includes a cryogen processing gas 50 within the cryogenic processing equipment, wherein the cryogen processing gas is circulated in an inner chamber 52 of cryogenic processing equipment 28 to facilitate additional cooling of the food products 36.

The probe control unit 11 may be coupled to the first flow probe 12 by first probe conduit 20, and to the second flow probe 14 by second probe conduit 22. The probe control unit 11 may include circuitry, processing devices, memory, and/or other elements to collect information from the first and second flow probes 12,14. The first and second probe conduits 20,22 may contain a plurality of wires or wiring necessary to control the temperatures of first and second probes 12,14. The flow probe control 11 may, in turn, exchange information regarding the operating conditions inside the exhaust duct 24, as shown by the broken line 16 connected to the display unit 18. The flow probe control 11 may be constructed and arranged to determine a velocity of the spent cryogen exhaust gas 26 moving through the exhaust duct 24 from the cryogenic processing equipment 28 to the exhaust outlet 34. As can be appreciated, the flow probe control 11 may be positioned at other locations external to the exhaust duct 24.

The flow probe control 11 may control operation of the first and second flow probes 12,14 in a manner that enables the flow probe control to derive accurate information without interruption of a flow of the spent cryogen exhaust gas 26 in the exhaust duct 24. Indeed, the flow probe control 11 may energize the first and second flow probes 12,14 to determine a heat transfer coefficient between the first and second flow probes and the cryogen exhaust gas 26. The heat transfer coefficient may then be used to determine a velocity of the cryogen exhaust gas 26 inside the exhaust duct 24. Notably, determining the heat transfer coefficient generally involves knowing an ambient temperature inside of the exhaust duct 26. However, and contrary to existing devices and sensors, the flow probe control 11 of the present embodiments does not need to directly measure the ambient temperature inside the exhaust duct 26 for any period of time. Instead, the first and second flow probes 12,14 may be operated at different elevated temperatures so that the first and second flow probes are not subjected to the accumulation of ice or other frozen particles. As a result, the first and second flow probes 12, 14 avoid ice build-up, damage and interruptions to their operations that may otherwise occur if continually operating at the low ambient temperatures within the exhaust duct 24, as discussed above. The flow probe control 11 may operate the first and second flow probes 12,14 at elevated temperatures, and use information obtained from the operation of the first and second flow probes to determine or calculate the ambient temperature inside the exhaust duct 24 (which is described in further detail below). In all embodiments, the flow probe control 11 maintains the first flow probe 12 and the second flow probe 14 at different elevated temperatures. By operating in this manner, the first and second flow probes 12,14 remain clear of ice and/or prevents a detrimental accumulation of ice on and damage to the first and second flow probes, which in turn prevents interruptions to their operation and accuracy.

The elevated temperature levels at which each of the first and second flow probes 12,14 operate is greater than a predetermined threshold temperature. The predetermined threshold temperature may correspond to a temperature sufficient to prevent and/or minimize the detrimental accumulation of ice on the first and second flow probes 12,14. In some examples, the predetermined threshold temperature may comprise a temperature greater than 100° Fahrenheit (F) or 38° Celsius (C), and up to a temperature of 250° F. (121° C.). In other examples, the predetermined threshold temperature may comprise a temperature greater than 32° F. (0° C.) or 90° F. (32° C.). In still other examples, other predetermined temperature thresholds can be used. Generally, the predetermined threshold temperature will be higher than a temperature of the interior of the chamber 52 of the cryogenic processing equipment 28.

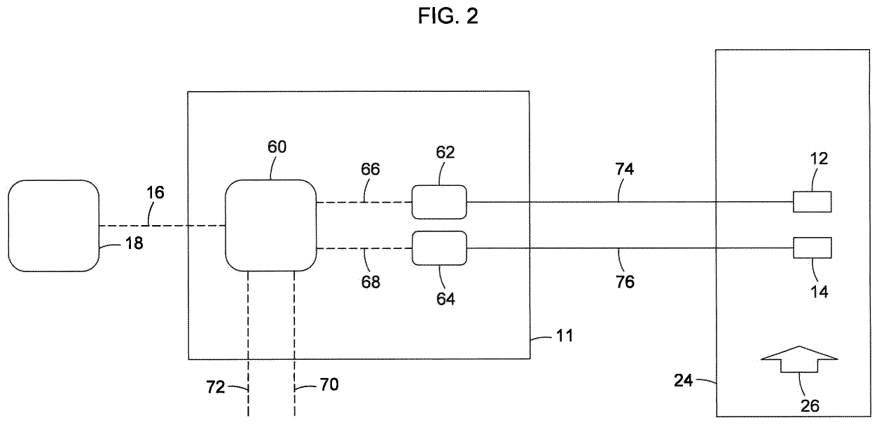

Referring also to FIG. 2, the first and second flow probes 12,4, the display unit 18, and the flow probe control 11 of FIG. 1 are shown. The first and second flow probes 12, 14 may be mounted in the exhaust duct 24 such that the first and second flow probes are exposed to the spent cryogen exhaust gas 26 being moved from the cryogenic processing equipment 28 through the exhaust 34. The flow probe control 11 consists of a first probe circuit 62, a second probe circuit 64, and a flow probe controller 60. The first flow probe 12 is connected to the first probe circuit 62, and the second flow probe 14 is connected to the second probe circuit 64.

The connection or coupling of the first flow probe 12 to the first flow probe circuit 62 represented by the line 20 in FIG. 1 may include a first flow probe conduit 74 extending from and connecting the first flow probe with the first probe circuit 62. The first flow probe conduit 74 may be a suitable tube or pipe through which signal lines and/or power lines may electrically connect the first flow probe 12 to the first probe circuit 62. The first probe circuit 62 is connected to the flow probe controller 60 by first probe circuit controls 66. The function of first probe circuit controls 66 is to provide for or enable the first probe circuit 62 to convey information concerning the status of the first flow probe 12 to the flow probe controller 60. In addition, the flow probe controller 60 is able to send signals and power to the first probe circuit 62 such that the first flow probe circuit is able to send signals and/or power to the first flow probe 12.

The connection or coupling of the second flow probe 14 to the second probe circuit 64 represented by the line 22 in FIG. 1 may include a second flow probe conduit 76 extending from and connecting the second flow probe with the second probe circuit 64. The second flow probe conduit 76 may be a suitable tube or pipe through which signal lines and/or power lines may electrically connect the second flow probe 14 to the second probe circuit 64. The second probe circuit 64 is connected to the flow probe controller 60 by the second probe circuit controls 68. The function of second probe circuit controls 68 is to provide for or enable the second probe circuit 64 to convey information concerning the status of the second flow probe 14 to the flow probe controller 60. In addition, the flow probe controller 60 is able to send signals and power to the second probe circuit 64 such that the second probe circuit is able to send signals and/or power to the second flow probe 12.

The first and second flow probe conduits 74,76 may each be replaced by sheathing positioned around the signal lines and/or power lines connecting the flow probe control 11 to the first and second flow probes 12,14. Further, the first and second flow probe conduits 74,76 may instead be a single shared conduit.

The flow probe controller 60 receives positive power 72 and negative power 70 from an external source. The flow probe controller 60 adjusts the positive power 72 and the negative power 70, and provides signals and power needed at the first and second probe circuits 62,64. The flow probe controller 60 receives signals from first and second probe circuits 62,64, and uses said signals to calculate: the operational status of the first flow probe 12 and the second flow probe 14, the heat transfer coefficient of the first flow probe and the second flow probe resulting from the flow of the spent cryogen exhaust gas 26, and the ambient temperature of the spent cryogen exhaust gas. Further, the flow probe controller 60 can use the calculated heat transfer coefficient and ambient temperature to derive a velocity for the cryogen exhaust gas 26 moving in and through the exhaust duct 24.

A flow probe signal line 16 may electrically connect the flow probe controller 60 to the display unit 18. The flow probe controller 60 sends power and signals to the display unit 18 such that any number of variables existing or stored in the flow probe controller may be displayed at the display unit. These variables may include: velocity, heat transfer coefficient, probe temperatures, ambient temperature, probe status, and alarm status.

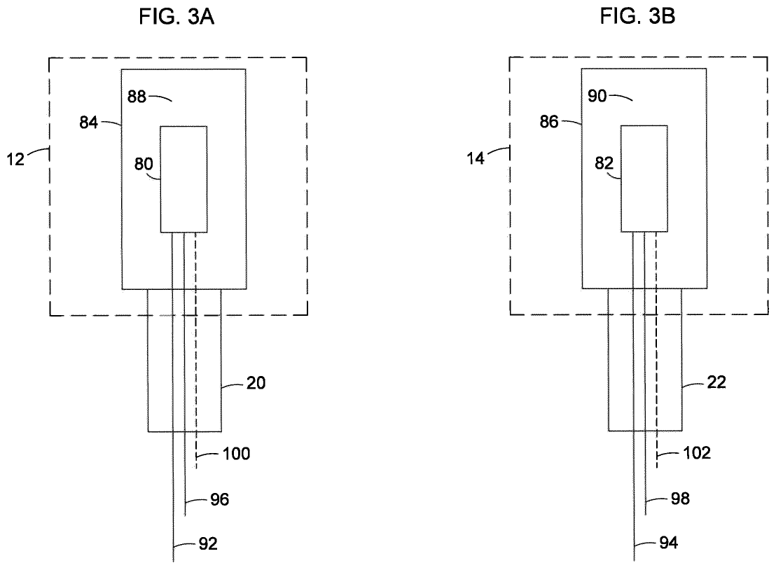

Turning now to FIG. 3A, a schematic view shows further aspects of the first flow probe 12 and the second flow probe 14. The first flow probe 12 and the second flow probe 14 are each shown exposed in FIGS. 1 and 2 to the spent cryogen exhaust gas 26 in the exhaust duct 24. The first flow probe 12 and the second flow probe 14 may each be configured similarly.

The first flow probe 12 (the “probe 12”) may include a first flow probe enclosure 84 (the “enclosure 84”) and a first resistive heater 80 (the “resistive heater 80”). The enclosure 84 may surround the resistive heater 80. The resistive heater 80 may be connected to the enclosure 84 using a conductive adhesive 88 or other suitable fastener or attachment. The resistive heater 80 and the enclosure 84 may be positioned within the exhaust duct 24 so that the enclosure 84 is exposed to the cryogen exhaust gas 26 moving through the exhaust duct and away from the cryogenic processing equipment 28. The resistive heater 80 may be electrically coupled to the first probe circuit 62 (see FIG. 2) via one or more wires or lines positioned inside the first probe conduit 20. While the first probe conduit 20 may not be required, the first probe conduit may be utilized to guide and support the wires or lines electrically coupling the probe 12 to the first probe circuit 62.

The probe 12 is shown exposed to the spent cryogen exhaust gas 26 in the exhaust duct 24. The enclosure 84 does not necessarily have to be used if the resistive heater 80 is durable enough to survive conditions in the exhaust duct 24, including conditions during cleaning of the exhaust duct. The resistive heater 80 may be, for example, a standard off-the-shelf 100 ohm resistance temperature detector (or RTD).

In the embodiment shown in FIG. 3A, a first control wire 92, a second control wire 96, and a flow probe signal line 100 may extend through the first probe conduit 20. The first and second control wires 92,96 may electrically couple the heater 80 to a power source (not shown) to energize the resistive heater. The first and second control wires 92,96 may also be used to collect information regarding the operating conditions of the resistive heater 80. The flow probe signal line 100 (the “signal line 100”) is an optional wire or line that may be included to provide information from the first flow probe 12 to the flow probe controller 60. For example, to mitigate the resistance of the first and second control wires 92,96 if and when the distance between the probe 12 and the probe control unit 11 is excessive, the signal line 100 (acting as a third control wire) may be included to provide a suitable signal for the collection of information. In other examples, additional wires or lines may be included such as additional signal lines from the probe 12.

Referring now to FIG. 3B, the second flow probe 14 (the “probe 14”) may be constructed and arranged similar to the probe 12 described above. The probe 14 may include a second flow probe enclosure 86 (the “enclosure 86”) and a second resistive heater 82 (the “resistive heater 82”). The enclosure 86 may surround the resistive heater 82. The resistive heater 82 may be connected to the enclosure 86 using a conductive adhesive 90 or other suitable fastener or attachment. The resistive heater 82 and the enclosure 86 may be positioned within the exhaust duct 24 so that the enclosure 86 is exposed to the cryogen exhaust gas 26 moving through the exhaust duct and away from the cryogenic processing equipment 28. The resistive heater 82 may be electrically coupled to the second probe circuit 64 (see FIG. 2) via one or more wires or lines positioned inside the second probe conduit 22. While the second probe conduit 22 may not be required, the second probe conduit may be utilized to guide and support the wires or lines electrically coupling the probe 14 to the second probe circuit 64.

The probe 14 is shown exposed to the spent cryogen exhaust gas 26 in the exhaust duct 24. The enclosure 86 does not necessarily have to be used if the resistive heater 82 is durable enough to survive conditions in the exhaust duct 24, including conditions during cleaning of the exhaust duct. The resistive heater 82 may be, for example, a standard off-the-shelf 100 ohm resistance temperature detector (or RTD).

In the embodiment shown in FIG. 3B, a third control wire 94, a fourth control wire 98, and a second flow probe signal line 102 may extend through the second probe conduit 22. The third and fourth control wires 94,98 may electrically couple the resistive heater 82 to a power source (not shown) to energize the resistive heater. The third and fourth control wires 94,98 may also be used to collect information regarding the operating conditions of the resistive heater 82. The flow probe signal line 102 (the “signal line 102”) is an optional wire or line that may be included to provide information from the probe 14 to the flow probe controller 60. For example, to mitigate the resistance of the third and fourth control wires 94,98 if and when the distance between the probe 14 and the probe control unit 11 is excessive, the signal line 102 (acting as a fifth control wire) may be included to provide a suitable signal for the collection of information. In other examples, additional wires or lines may be included such as additional signal lines from the probe 14.

To mitigate the resistance of the first, second, third, and fourth control wires 92, 96, 94, 98 (the “control wires 92-98”) if and when the distance between the probes 12,14 and the flow probe control 11 is excessive, the flow probe signal lines 100, 102 may be included to provide a suitable signal for the collection of information. In a preferred example, the resistance of the control wires 92-98 may be less than 1 ohm. It is desirable to provide a configuration in which the resistance of the control wires 92-98 do not significantly contribute resistance to the circuit of electricity passing from the flow probe control 11 through control wires 92-98, resistive heaters 80 & 82, and returning to the flow probe control 11 so that the measurement of the temperature at the probes 12,14 are accurately determined. For example, if the control wires 92-98 were implemented as 16 American wire gauge (AWG) wires with a length of 200 feet (60.96 m), the control wires 92-98 could add 1.6 ohms to the circuit and raise the apparent resistance of the resistive heaters 80,82 by a corresponding amount. This increased apparent resistance of the resistive heaters 80,82 could then correspond to a “temperature offset” of approximately 7° F. (i.e., a temperature difference of 4° C.) when the temperatures of the resistive heaters 80,82 are determined by the flow probe controller 60. In such instance, this circumstance may be mitigated by adding the flow probe signal lines 100,102. In other examples, additional wires or lines may be included such as additional signal lines from the probes 12, 14.

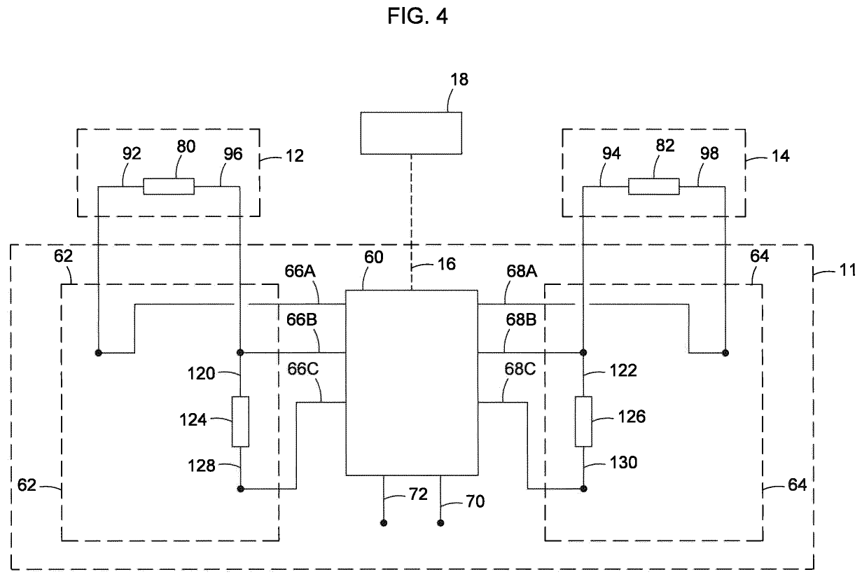

Turning now to FIG. 4, the probe control unit 11 is shown in further detail. In this embodiment, the probe 12 is connected to the first probe circuit 62 by the first control wire 92 and the second control wire 96. The first probe circuit controls 66 consists of three wires: a first probe power wire 66A, a first probe current wire 66B, and a first probe ground wire 66C. Within the first probe circuit 62, the first probe power wire 66A connects directly with the first control wire 92. The second control wire 96 connects to the first probe current wire 66B and first upper current wire 120. The first upper current wire 120 connects to first current resistor 124. The first current resistor 124 connects to first lower current wire 128. The first lower current wire 128 connects to first probe ground wire 66C.

The flow probe controller 60 may generate a voltage (V1) in the first probe power wire 66A which is transmitted via the first control wire 92 to the resistive heater 80. The resistance of the resistive heater 80 (R2) will limit the flow of current (I1) through resistive heater 80. This current (I1) will flow along the second control wire 96 and then the first upper current wire 120. The current (I1) will pass through the first current resistor 124 and then the first lower current wire 128. The current (I1) will then flow to the flow probe controller 60 along the first probe ground wire 66C. As this current (I1) passes through the first current resistor 124, the current will generate a first current voltage (V2). This voltage (V2) will be sensed by the first probe current wire 66B.

The difference in signals between the first probe power wire 66A (V1) and the first probe current wire 66B (V2) allow the flow probe controller 60 to calculate the voltage across the resistive heater 80 (V3). The resistance of the first current resistor 124 (R1) and the voltage of the first probe current wire 66B (V2) allow the flow probe controller 60 to calculate the current passing through the resistive heater 80 (I1). From these values, the flow probe controller 60 can calculate the power being dissipated by the resistive heater 80 (Q1) as well as the resistance of the resistive heater 80 (R2). From the first dissipated power Q1, the flow probe controller 60 is able to calculate a first heat flux (HF1) using surface area A1 of the probe 12. The first resistive heater 80 may be made of a known material with a known relationship between temperature and resistance. This known relationship may be leveraged to determine a temperature of the resistive heater 80 (T1) according to the following equation:

$$V 3 = V 1 - V 2$$

$$I 1 = \frac{V 2}{R 1}$$

$$Q 1 = V 3 \times I 1$$

$$HF 1 = \frac{Q 1}{A 1}$$

$$R 2 = \frac{V 3}{I 1}$$

The flow probe controller 60 may operate to cause a voltage V1 to be delivered to the resistive heater 80 within the probe 12. In response, the resistive heater 80 may be heated to a temperature greater than the first predetermined threshold temperature as previously described. Further, the resistive heater 80 may be heated to a temperature lower than the first predetermined threshold temperature. The flow probe controller 60 will use the results of its calculations to adjust the voltage V1 in the first probe power wire 66A such that the resistive heater 80 may be heated to the first predetermined threshold temperature.

The probe 14 is connected to the second probe circuit 64 by the third control wire 94 and the fourth control wire 98. The second probe circuit controls 68 consists of three wires: a second probe power wire 68A, a second probe current wire 68B, and a second probe ground wire 68C. Within the second probe circuit 64, the second probe power wire 68A connects directly with the third control wire 94. The fourth control wire 98 connects to the first probe current wire 68B and second upper current wire 122. The second upper current wire 122 connects to second current resistor 126. The second current resistor 126 connects to second lower current wire 130. The second lower current wire 130 connects to second probe ground wire 68C. The flow probe controller 60 may generate a voltage (V4) in the second probe power wire 68A which is transmitted via the third control wire 94 to the resistive heater 82. The resistance of resistive heater 82 (R4) will limit the flow of current (I2) through resistive heater 82. This current (I2) will flow along the fourth control wire 98 and then the second upper current wire 122. The current (I2) will pass through the second current resistor 126 and then the second lower current wire 130. The current (I2) will then flow to the flow probe controller 60 along the second probe ground wire 68C. As this current (I2) passes through the second current resistor 126, it will generate a second current voltage (V5). This second current voltage (V5) will be sensed by the second probe current wire 68B.

The difference in signals between the second probe power wire 68A (V4) and the second probe current wire 68B (V5) allow the flow probe controller 60 to calculate the voltage across the resistive heater 82 (V6). The resistance of the second current resistor 126 (R3) and the voltage of the second probe current wire 68B (V5) allow the flow probe controller 60 to calculate the current passing through the resistive heater 82 (12). From these values, the flow probe controller 60 can calculate the power being dissipated by the resistive heater 82 (Q2) as well as the resistance of the resistive heater 82 (R4). From the second dissipated power Q2, the flow probe controller 60 is able to calculate a second heat flux (HF2) using the surface area A2 of the probe 14. The resistive heater 82 may be made of a known material with a known relationship between temperature and resistance. This known relationship may be leveraged to determine a temperature of the resistive heater 82 (T2) according to the following equation:

$$V 6 = V 4 - V 5$$

$$I 2 = \frac{V 5}{R 3}$$

$$Q 2 = V6 \times I 2$$

$$HF 2 = \frac{Q 2}{A 2}$$

$$R 4 = \frac{V 6}{I 2}$$

The flow probe controller 60 may operate to cause a voltage V4 to be delivered to the resistive heater 82 within the probe 14. In response, the resistive heater 82 may be heated to a temperature greater than the second predetermined threshold temperature as previously described. Further, the resistive heater 82 may be heated to a temperature lower than the second predetermined threshold temperature. The flow probe controller 60 will use the results of its calculations to adjust the voltage V4 in the second probe power wire 68A such that the resistive heater 82 may be heated to the second predetermined threshold temperature.

If the resistance is different between the first and second current resistors 124,126, it will be possible for the voltages of the first and second probe power wires 66A,68A to be identical, yet still heat the resistive heaters 80,82 to two different temperatures.

The flow probe controller 60 may include a processor, memory and computer-readable instructions, and may be configured as a computing device, application specific circuit, programmable logic controller (PLC) or other suitable controller.

The flow probe controller 60 may operate to determine a heat transfer coefficient (U) inside the exhaust duct 24. From the heat transfer coefficient, a velocity of the spent cryogen exhaust gas 26 in the exhaust duct 24 may be determined. For example, the flow probe controller 60 may generate a difference in the heat fluxes (ΔHF) between the resistive heater 80 and the resistive heater 82. Additionally, the flow probe controller 60 may generate a difference in the temperatures (ΔT) between the resistive heater 80 and the resistive heater 82. Moreover, the flow probe controller 60 may then use both the difference in heat fluxes ΔHF and the differences in the temperatures ΔT to calculate the heat transfer coefficient U. Using either of the probe 12 or the probe 14 as a reference, the flow probe controller 60 may generate a value for the temperature T3 of the spent cryogen exhaust gas 26 using the following equation:

$$Δ HF = HF 1 - HF 2$$

$$Δ T = T 1 - T 2$$

$$U = \frac{Δ H F}{Δ T}$$

$$T 3 = T 1 - \frac{H F 1}{U} = T 2 - \frac{H F 2}{U}$$

In all the embodiments, flow probe controller 60 maintains the temperature of the resistive heater 80 at the first predetermined threshold temperature, and the resistive heater 82 at the second first predetermined threshold temperature. This allows the calculation of the heat transfer coefficient U to be unaffected by the energy balance which results from the change in temperature of the probe 12 or the probe 14. The first and second predetermined threshold temperatures may be changed periodically by the flow probe controller 60 or the user in order to, for example, improve the sensitivity of the heat transfer coefficient calculations. However, during the measurement of the heat transfer coefficient within the exhaust duct 24, the first and second predetermined threshold temperatures remain fixed and the flow probe controller 60 maintains the temperature of the resistive heaters 80,82 at their respective predetermined threshold temperatures.

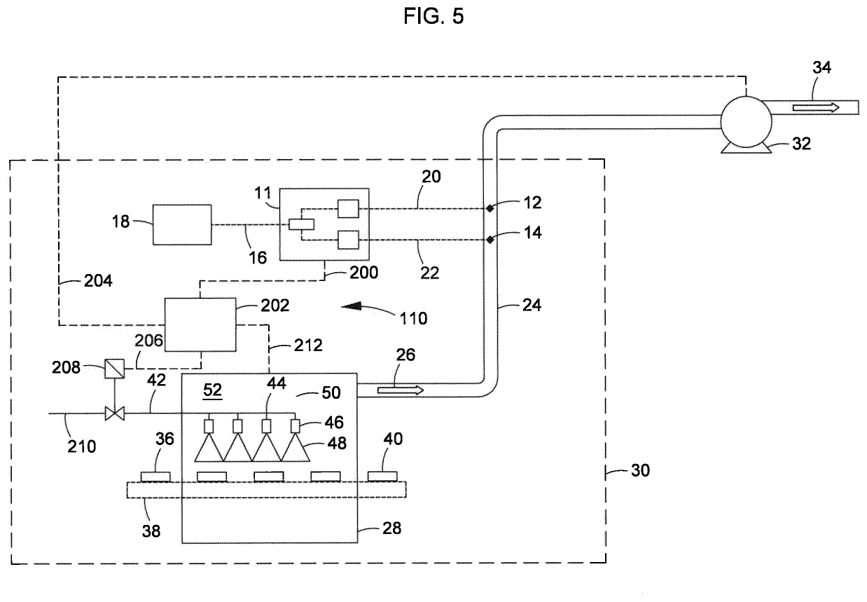

Turning now to FIG. 5, this embodiment of an apparatus 110 describes how the probe control unit 11 may send and/or receive signals and power using probe control signals 200 with a cryogenic equipment control unit 202. Referring also to FIG. 4, a source of positive power 72 and of negative power 70 may be from the cryogenic equipment control unit 202. In addition, the probe control unit 11 may send the probe control signals 200 to the cryogenic equipment control unit 202 which causes the cryogenic equipment control unit to make changes to the operation of the cryogenic processing equipment 28. For example, based upon a predetermined threshold for the heat transfer coefficient, the cryogenic equipment control unit 202 may adjust the operating setpoint of the cryogenic processing equipment 28 via equipment controls 212. Moreover, the cryogenic equipment control unit 202 may control, and therefore interrupt, the flow of supply cryogen 210 to the feed cryogen 42 by sending a signal 206 to control valve 208 resulting in the closure of the control valve 208. The control valve 28 therefore modulates the flow of the supply cryogen 210 to the feed cryogen 42 based upon the opening and closing position of the control valve. Further, the cryogenic equipment control unit 202 may send a signal 204 to exhaust blower 32 in order to increase or decrease the flow of the spent cryogen exhaust gas 26 in the exhaust duct 24.

Another embodiment includes the probe control signals 200 from the cryogenic equipment control unit 202 being delivered to the probe control unit 11. The probe control signals 200 can set and or/adjust the predetermined threshold for the heat transfer coefficient. For example, the user may adjust the predetermined threshold for the heat transfer coefficient on the cryogenic equipment control unit 202. The cryogenic equipment control unit 202 conveys this value in the probe control signal 200 to the probe control unit 11. If the probe control unit 11 later detects that the heat transfer coefficient in the exhaust duct 24 is below said predetermined threshold, the probe control unit sends a signal to the cryogenic equipment control unit 202, wherein the cryogenic equipment control unit can respond by closing the control valve 208.

For all embodiments described above, a temperature at each one of the resistive heaters 80,82 remains constant, even though the temperatures are different at the resistive heaters, for determining the heat transfer coefficient of the exhaust gas.

Therefore, a first embodiment is provided of an apparatus for measuring flow of cryogen exhaust gas from a freezer, which includes a flow probe comprising a first resistive heater and a second resistive heater, the first and second resistive heaters adapted for being exposed to the cryogen exhaust gas; and a flow probe control coupled to the first resistive heater and the second resistive heater, the flow probe control comprising a control circuit constructed and arranged to operate the first resistive heater at a first temperature, operate the second resistive heater at a second temperature different from the first temperature, wherein the first temperature and the second temperature each remain constant and greater than a predetermined threshold temperature, and determine a heat transfer coefficient for the flow of the cryogen exhaust gas over the first and second resistive heaters. Additional embodiments are provided below.

A second embodiment of the apparatus of the first embodiment, includes the flow probe control is further constructed and arranged to indirectly determine a temperature of the cryogen exhaust gas at the flow probe.

A third embodiment of the apparatus of the second embodiment, includes the control circuit is adapted to determine the temperature of the cryogen exhaust gas based on a first measured current through the first resistive heater operated at the first temperature, and a second measured current through the second resistive heater operated at the second temperature.

A fourth embodiment of the apparatus of the second embodiment, includes the flow probe control is constructed and arranged to determine the heat transfer coefficient and a temperature of the cryogen exhaust gas from information signals received from the first and second resistive heaters.

A fifth embodiment of the apparatus of the second embodiment, includes the temperature of the cryogen exhaust gas is determined without a sensor directly measuring the temperature of the exhaust gas.

A sixth embodiment of the apparatus of the first embodiment, includes the predetermined threshold temperature is at least 100° Fahrenheit (38° Celsius).

A seventh embodiment of the apparatus of the first embodiment, includes the flow probe is mounted in an exhaust duct of the freezer.

An eighth embodiment of the apparatus of the first embodiment, further includes a control valve to control a flow of cryogen to the freezer, the control valve constructed and arranged to be modulated based upon the heat transfer coefficient in the exhaust gas.

A ninth embodiment of the apparatus of the first embodiment, includes the control circuit is further constructed and arranged to operate a third resistive heater at a third temperature, the third temperature being constant and different from the first temperature and the second temperature.

Additionally, a tenth embodiment of a method of measuring flow of cryogen exhaust gas from a freezer, includes: energizing a first resistive heater with a first voltage to maintain a first temperature; energizing a second resistive heater with a second voltage to maintain a second temperature different from the first temperature; controlling the first temperature and the second temperature to be constant; wherein the first temperature and the second temperature are greater than a predetermined threshold temperature; positioning the first and second resistive heaters in the cryogen exhaust gas; determining a heat transfer coefficient for the flow of the cryogen exhaust gas over the first and second resistive heaters. Additional embodiments are provided below.

An eleventh embodiment of the method of the tenth embodiment, further includes indirectly determining a temperature of the cryogen exhaust gas at the first and second resistive heaters.

A twelfth embodiment of the method of the eleventh embodiment, further includes mounting the first resistive heater in a first probe, and mounting the second resistive heater in a second probe, and determining the temperature of the cryogen exhaust gas using the first and second resistive heaters.

A thirteenth embodiment of the method of the tenth embodiment, further includes measuring a first current of the first voltage; measuring a second current of the second voltage; and determining the temperature of the cryogen exhaust gas at the first and second resistive heaters based on the first current and the second current, and the first voltage and the second voltage.

A fourteenth embodiment of the method of the eleventh embodiment, further includes determining the heat transfer coefficient and the temperature of the cryogen exhaust gas without a sensor directly measuring the temperature of the exhaust gas.

A fifteenth embodiment of the method of the tenth embodiment, includes the predetermined threshold temperature is at least 100° Fahrenheit (38° Celsius).

A sixteenth embodiment of the method of the twelfth embodiment, further includes mounting the first and second probes in an exhaust duct of the freezer.

A seventeenth embodiment of the method of the tenth embodiment, further includes sending a signal to a control valve to modulate a flow of cryogen to the freezer.

An eighteenth embodiment of the method of the tenth embodiment, includes the cryogen is selected from the group consisting of nitrogen and carbon dioxide

It will be understood that the embodiments described herein are merely exemplary, and that a person skilled in the art may make variations and modifications without departing from the spirit and scope of the invention. All such variations and modifications are intended to be included within the scope of the invention as described herein and provided for in the appended claims. It should be understood that the embodiments described above are not only in the alternative but can be combined.

What is claimed is:

1. An apparatus for measuring flow of cryogen exhaust gas from a freezer, comprising:
a flow probe comprising a first resistive heater and a second resistive heater, the first and second resistive heaters adapted for being exposed to the cryogen exhaust gas; and
a flow probe control coupled to the first resistive heater and the second resistive heater, the flow probe control comprising a control circuit constructed and arranged to:
operate the first resistive heater at a first temperature,
operate the second resistive heater at a second temperature different from the first temperature,
wherein the first temperature and the second temperature each remain constant and greater than a predetermined threshold temperature, and
determine a heat transfer coefficient for the flow of the cryogen exhaust gas over the first and second resistive heaters.

2. The apparatus of claim 1, wherein the flow probe control is further constructed and arranged to indirectly determine a temperature of the cryogen exhaust gas at the flow probe.

3. The apparatus of claim 2, wherein the control circuit is adapted to determine the temperature of the cryogen exhaust gas based on a first measured current through the first resistive heater operated at the first temperature, and a second measured current through the second resistive heater operated at the second temperature.

4. The apparatus of claim 2, wherein the flow probe control is constructed and arranged to determine the heat transfer coefficient and a temperature of the cryogen exhaust gas from information signals received from the first and second resistive heaters.

5. The apparatus of claim 2, wherein the temperature of the cryogen exhaust gas is determined without a sensor directly measuring the temperature of the exhaust gas.

6. The apparatus of claim 1, wherein the predetermined threshold temperature is at least 100° Fahrenheit (38° Celsius).

7. The apparatus of claim 1, wherein the flow probe is mounted in an exhaust duct of the freezer.

8. The apparatus of claim 1, further comprising a control valve to control a flow of cryogen to the freezer, the control valve constructed and arranged to be modulated based upon the heat transfer coefficient in the exhaust gas.

9. The apparatus of claim 1, wherein the control circuit is further constructed and arranged to operate a third resistive heater at a third temperature, the third temperature being constant and different from the first temperature and the second temperature.

10. A method of measuring flow of cryogen exhaust gas from a freezer, comprising:
energizing a first resistive heater with a first voltage to maintain a first temperature;
energizing a second resistive heater with a second voltage to maintain a second temperature different from the first temperature;
controlling the first temperature and the second temperature to be constant;
wherein the first temperature and the second temperature are greater than a predetermined threshold temperature;
positioning the first and second resistive heaters in the cryogen exhaust gas; and
determining a heat transfer coefficient for the flow of the cryogen exhaust gas over the first and second resistive heaters.

11. The method of claim 10, further comprising indirectly determining a temperature of the cryogen exhaust gas at the first and second resistive heaters.

12. The method of claim 11, further comprising mounting the first resistive heater in a first probe, and mounting the second resistive heater in a second probe, and determining the temperature of the cryogen exhaust gas using the first and second resistive heaters.

13. The method of claim 10, further comprising:
measuring a first current of the first voltage;
measuring a second current of the second voltage; and
determining the temperature of the cryogen exhaust gas at the first and second resistive heaters based on the first current and the second current, and the first voltage and the second voltage.

14. The method of claim 11, further comprising:
determining the heat transfer coefficient and the temperature of the cryogen exhaust gas without a sensor directly measuring the temperature of the exhaust gas.

15. The method of claim 10, wherein the predetermined threshold temperature is at least 100° Fahrenheit (38° Celsius).

16. The method of claim 12, further comprising mounting the first and second probes in an exhaust duct of the freezer.

17. The method of claim 10, further comprising sending a signal to a control valve to modulate a flow of cryogen to the freezer.

18. The method of claim 10, wherein the cryogen is selected from the group consisting of nitrogen and carbon dioxide.
